(19) United States
(12) Patent Application Publication
(10) Pub. No.: US 2023/0262268 A1
(43) Pub. Date: Aug. 17, 2023

(54) CHROMA FORMAT DEPENDENT QUANTIZATION MATRICES FOR VIDEO ENCODING AND DECODING

(71) Applicant: InterDigital VC Holdings France, SAS, Cesson-Sevigne (FR)

(72) Inventors: Philippe De Lagrange, Betton (FR); Phillippe Bordes, LAILLE (FR); Franck Galpin, Thorigne-Fouillard (FR); Antoine Robert, Mézières Sur Couesnon (FR)

(21) Appl. No.: 17/621,483

(22) PCT Filed: Jun. 23, 2020
(86) PCT No.: PCT/EP2020/067503

§ 371 Date: Dec. 21, 2021

(30) Foreign Application Priority Data
Jul. 2, 2019 (EP) 19305903.7

(51) Int. Cl. H04N 19/94; H04N 19/186; H04N 19/172; H04N 19/46

(52) U.S. Cl. CPC H04N 19/94; H04N 19/186; H04N 19/172; H04N 19/46

(57) ABSTRACT

In a video coding system, it is proposed to transmit only a luma quantization matrix and no chroma quantization matrix when the chroma format is monochrome, and otherwise (i.e. not monochrome) to transmit at least both a luma quantization matrix and a chroma quantization matrix. This allows to avoid the transmission of data elements that are useless. It allows to improve simultaneously the encoding (less operations to perform), the transmission (less data to be transmitted) and decoding (less operations to perform).

### CROSS REFERENCE TO RELATED APPLICATIONS

This application is a U.S. National Stage Application under 35 U.S.C. 371 of International Application PCT/EP2020/067503, filed Jun. 23, 2020, which is incorporated herein by reference in its entirety.

This application claims the benefit of European Patent Application No. 19305903, filed Jul. 2, 2019, which is incorporated herein by reference in its entirety.

### TECHNICAL FIELD

The disclosure is in the field of video compression, and at least one embodiment relates more specifically to a video coding system with chroma format dependent quantization matrices.

### BACKGROUND ART

To achieve high compression efficiency, image and video coding schemes usually employ prediction and transform to leverage spatial and temporal redundancy in the video content. Generally, intra or inter prediction is used to exploit the intra or inter frame correlation, then the differences between the original image block and the predicted image block, often denoted as prediction errors or prediction residuals, are transformed, quantized and entropy coded. During encoding, the original image block is usually partitioned/split into sub-blocks using various partitioning such as quad-tree for example. To reconstruct the video, the compressed data is decoded by inverse processes corresponding to the prediction, transform, quantization and entropy coding.

### SUMMARY

In at least one embodiment, it is proposed to transmit only a luma quantization matrix and no chroma quantization matrix when the chroma format is monochrome, and otherwise (i.e. not monochrome) to transmit at least both a luma quantization matrix and a chroma quantization matrix. This allows to avoid the transmission of data elements that are useless. It allows to improve simultaneously the encoding (less operations to perform), the transmission (less data to be transmitted) and decoding (less operations to perform).

According to a first aspect, a method for encoding data representative of a picture comprises obtaining a chroma format of the picture, in the condition that the chroma format is monochrome, encoding an information representative of at least one determined luma quantization matrix, otherwise encoding an information representative of at least one determined luma quantization matrix and at least one determined chroma quantization matrix, and encoding the picture using the determined matrices.

According to a second aspect, a method for decoding picture data comprises obtaining from a bitstream an information representative of the chroma format, in the condition that the chroma format is monochrome, decoding an information representative of at least one determined luma quantization matrix, otherwise decoding an information representative of at least one determined luma quantization matrix and at least one determined chroma quantization matrix, and decoding picture data using the obtained quantization matrices.

According to a third aspect, an apparatus comprising an encoder for encoding picture data, the encoder being configured to obtain a chroma format of the picture, in the condition that the chroma format is monochrome, encode an information representative of at least one determined luma quantization matrix, otherwise encode an information representative of at least one determined luma quantization matrix and at least one determined chroma quantization matrix, and encode the picture using the determined matrices.

According to a fourth aspect, an apparatus comprising a decoder for decoding picture data, the decoder being configured to obtain from a bitstream an information representative of the chroma format, in the condition that the chroma format is monochrome, decode an information representative of at least one determined luma quantization matrix, otherwise decode an information representative of at least one determined luma quantization matrix and at least one determined chroma quantization matrix, and decode picture data using the obtained quantization matrices.

One or more of the present embodiments also provide a non-transitory computer readable storage medium having stored thereon instructions for encoding or decoding video data according to at least part of any of the methods described above. One or more embodiments also provide a computer program product including instructions for performing at least part of any of the methods described above.

### BRIEF SUMMARY OF THE DRAWINGS

FIG. 1 illustrates a block diagram of a video encoder according to an embodiment.

FIG. 2 illustrates a block diagram of a video decoder according to an embodiment.

FIG. 3 illustrates a block diagram of an example of a system in which various aspects and embodiments are implemented.

FIG. 4 illustrates an example flowchart of QM decoding according to at least one embodiment.

FIG. 5 illustrates an example flowchart of an embodiment where chroma QM are inferred.

FIG. 6A describes an encoding method according to an embodiment.

FIG. 6B describes a decoding method according to an embodiment.

### DETAILED DESCRIPTION

Various embodiments relate to a post-processing method for a predicted value of a sample of a block of an image, the value being predicted according to an intra prediction angle, wherein the value of the sample is modified after the prediction so that it is determined based on a weighting of the difference between a value of a left reference sample and the obtained predicted value for the sample, wherein the left reference sample is determined based on the intra prediction angle. Encoding method, decoding method, encoding apparatus, decoding apparatus based on this post-processing method are proposed.

Moreover, the present aspects, although describing principles related to particular drafts of VVC (Versatile Video Coding) or to HEVC (High Efficiency Video Coding) specifications, are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

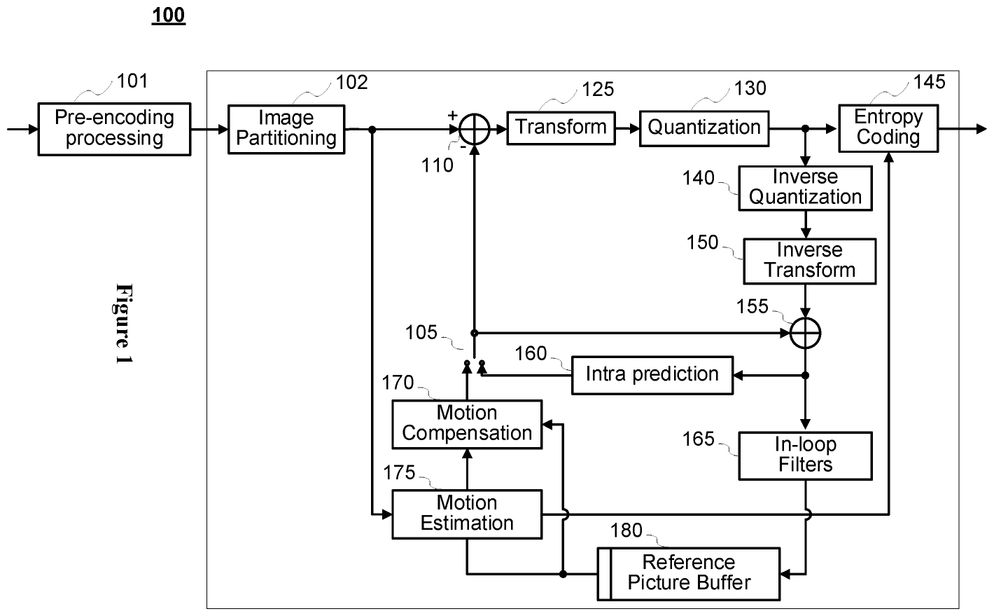

FIG. 1 illustrates a video encoder 100. Variations of this encoder 100 are contemplated, but the encoder 100 is described below for purposes of clarity without describing all expected variations. Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset), Adaptive Loop-Filter (ALF) filtering to reduce encoding artifacts. The filtered image is stored at a reference picture buffer (180).

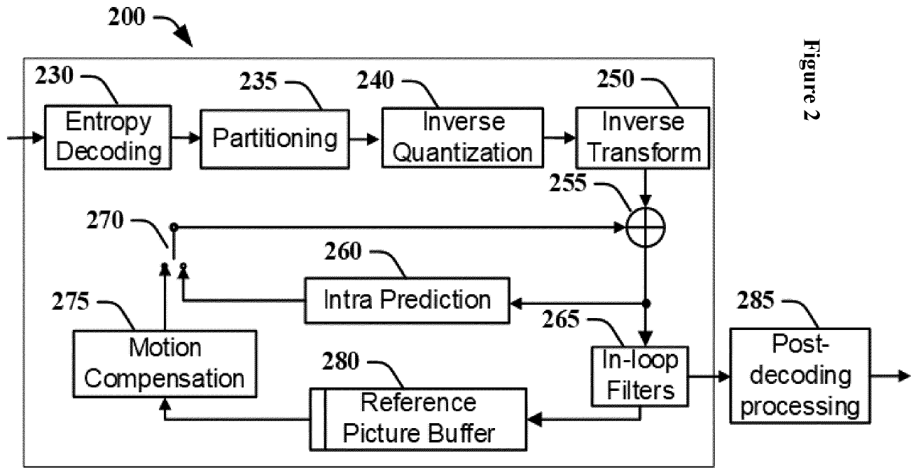

FIG. 2 illustrates a block diagram of a video decoder 200. In the decoder 200, a bitstream is decoded by the decoder elements as described below. Video decoder 200 generally performs a decoding pass reciprocal to the encoding pass. The encoder 100 also generally performs video decoding as part of encoding video data. In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

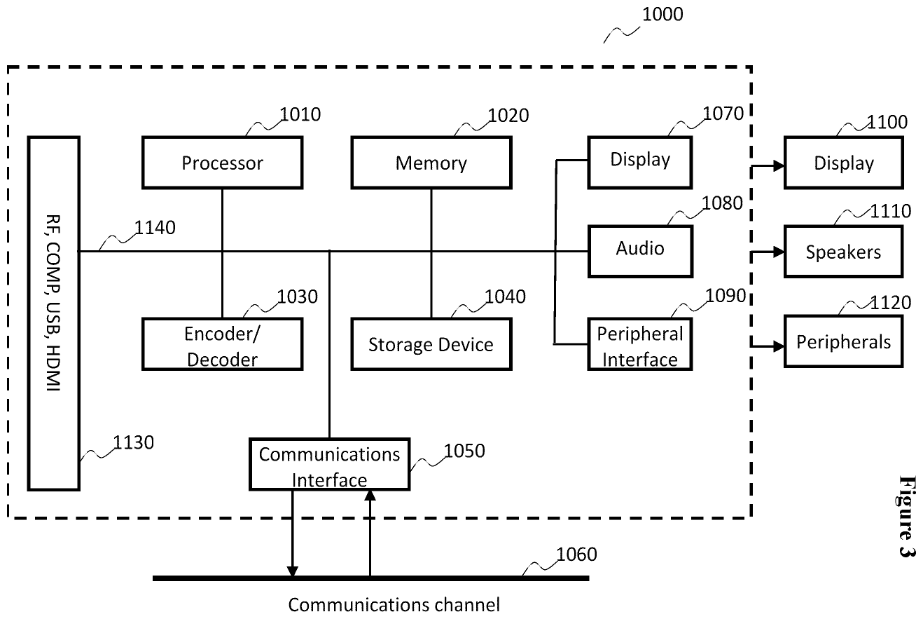

FIG. 3 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits.

The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

The technical field of the invention is related to the quantization step of a video compression scheme.

Video coding systems can use quantization matrices in the dequantization process where coded block frequency-transformed coefficients are scaled by the current quantization step and further scaled by a quantization matrix (QM) as follows, applied to the example of a HEVC coding system:

d[x][y]=Clip3(coeffMin,coeffMax,((TransCoeffLevel[xTbY][yTbY][cIdx][x][y]*m[x][y]*levelScale[qP%6]«(qP/6))+(1«(bdShift−1)))»bdShift)

Where:
TransCoeffLevel[ . . . ] are the transformed coefficients absolute values for the current block identified by its spatial coordinates xTbY, yTbY and its component index cIdx.
x and y are the horizontal/vertical frequency indices.
qP is the current quantization parameter.
the multiplication by levelScale[qP %6] and left shift by (qP/6) is the equivalent of the multiplication by quantization step qStep=(levelScale[qP %6]«(qP/6))
m[ . . . ][ . . . ] is the two-dimensional quantization matrix
bdShift is an additional scaling factor to account for image sample bit depth. The term (1«(bdShift−1)) serves the purpose of rounding to the nearest integer.
d[ . . . ] are the resulting dequantized transformed coefficients absolute values

For example, HEVC uses the syntax illustrated in Table 1 to transmit quantization matrices.

TABLE 1
Quantization matrix signaling in HEVC

| scaling_list_data( ) { | Descriptor |
|---|---|
| for( sizeId = 0; sizeId < 4; sizeId++ ) | |
| for( matrixId = 0; matrixId < 6; matrixId += ( sizeId = = 3 ) ? 3 : 1 ) { | |
| scaling_list_pred_mode_flag[ sizeId ][ matrixId ] | u(1) |
| if( !scaling_list_pred_mode_flag[ sizeId ][ matrixId ] ) | |
| scaling_list_pred_matrix_id_delta[ sizeId ][ matrixId ] | ue(v) |
| else { | |
| nextCoef = 8 | |
| coefNum = Min( 64, ( 1 << ( 4 + ( sizeId << 1 ) ) ) ) | |
| if( sizeId > 1 ) { | |
| scaling_list_dc_coef_minus8[ sizeId − 2 ][ | se(v) |
| matrixId ] | |
| nextCoef = scaling_list_dc_coef_minus8[ sizeId − | |
| 2 ][ matrixId ] + 8 | |
| } | |
| for( i = 0; i < coefNum; i++) { | |
| scaling_list_delta_coef | se(v) |
| nextCoef = ( nextCoef + scaling_list_delta coef + | |
| 256 ) % 256 | |
| ScalingList[ sizeId ][ matrixId ][ i ] = nextCoef | |
| } | |
| } | |
| } | |
| } | |

In this context:
scaling list data can be inserted in both sequence parameter set (SPS) and picture parameter set (PPS)
A different matrix is specified for each transform size (sizeId)
For a given transform size, 6 matrices are specified, for intra/inter coding and Y/Cb/Cr components
A matrix can be either
   Copied from a previously transmitted matrix of the same size, if scaling list_pred mode flag is zero (the reference matrixId is obtained as matrixId-scaling list_pred matrix id delta)
   Copied from default values specified in the standard (if both scaling list_pred mode flag and scaling list_pred matrix id delta are zero)
   Fully specified in DPCM coding mode, using exp-Golomb entropy coding, in up-right diagonal scanning order.
For block sizes greater than 8×8, only 8×8 coefficients are transmitted in order to save coded bits. Coefficients are then interpolated using zero-hold (=repetition), except for DC coefficient which is transmitted explicitly.
The QM syntax was designed for 4:2:0 chroma format (there are no chroma QMs for size 32). It was later adapted to 4:4:4 chroma by forcing sizeId to 3 to select QMs for 32×32 chroma blocks (i.e. copy QMs intended for 16×16).

The chroma format can be specified by chroma_format_idc in SPS syntax for example as in HEVC or VVC, and illustrated in Table 2:

TABLE 2
Chroma formats indicated by chroma_format_idc in VVC

| chroma_format_idc | Chroma format |
|---|---|
| 0 | Monochrome |
| 1 | 4:2:0 |
| 2 | 4:2:2 |
| 3 | 4:4:4 |

The use of quantization matrices similar to HEVC has been adopted in VVC draft 5 with some changes in syntax with extended QM prediction. In addition, compared to HEVC, VVC needs more quantization matrices due to a higher number of block sizes.

A QM can be identified by two parameters, matrixId and sizeId. The values of sizeId are illustrated in Table 3.

TABLE 3
QM size identifier depending on block size

| Luma block | Chroma block | QM sizeld | QM size |
|---|---|---|---|
| — | — | 0 | — |
| — | 2 × 2 | 1 | 2 × 2 |
| 4 × 4 | 4 × 4 | 2 | 4 × 4 |
| 8 × 8 | 8 × 8 | 3 | 8 × 8 |
| 16 × 16 | 16 × 16 | 4 | 8 × 8 + DC |
| 32 × 32 | 32 × 32 | 5 | 8 × 8 + DC |
| 64 × 64 | — | 6 | 8 × 8 + DC |

For block sizes greater than 8×8, only 8×8 coefficients+DC are transmitted. QM of the correct size is reconstructed using zero-hold interpolation. For example, for a 16×16 block, every coefficient is repeated twice in both directions, then the DC coefficient is replaced by the transmitted one.

For rectangular blocks, the size retained for QM selection (sizeId) is the larger dimension, i.e. maximum of width and height. For example, for a 4×16 block, a QM for 16×16 block size is selected. Then, the reconstructed 16×16 matrix is decimated vertically by a factor 4 to obtain the final 4×16 quantization matrix (i.e. 3 lines out of 4 are skipped).

For the following, we refer to QMs for a given family of block sizes (square or rectangular) of size-N, in relation to sizeId and the square block size it is used for: for example, for block sizes 16×16 or 16×4, the QMs are identified as size-16 (sizeId 4 in Table 3). The size-N notation is used to differentiate from exact block shape, and from the number of signaled QM coefficients (limited to 8×8, as shown in table 3).

A unique QM identifier is illustrated in table 4 where decimated chroma QMs (4:2:0) are specified and used, even for 4:4:4 picture encoding.

TABLE 4
Unified matrixId

| | | | | | | | | | | | |
|---|---|---|---|---|---|---|---|---|---|---|---|
| Y | INTRA | 0 | | 6 | | 12 | | 18 | | 24 | |
| | INTER | 1 | | 7 | | 13 | | 19 | | 25 | |
| Cb | INTRA | | 2 | | 8 | | 14 | | 20 | | 26 |
| | INTER | | 3 | | 9 | | 15 | | 21 | | 27 |
| Cr | INTRA | | 4 | | 10 | | 16 | | 22 | | 28 |
| | INTER | | 5 | | 11 | | 17 | | 23 | | 29 |

| TU size | 64 | | 32 | | 16 | | 8 | | 4 | |
|---|---|---|---|---|---|---|---|---|---|---|
| Signalled QM size | 8 × 8 + DC | | | | | 8 × 8 | | 4 × 4 | | 2 × 2 |
| Block size: max(width, | 64 | 32 | | 16 | | 8 | | 4 | | 2 |
| height) (in 4:2:0 chroma | | | | | | | | | | |
| format) | | | | | | | | | | |
| Block size: max(width, | 64 | | 32 | | 16 | | 8 | | 4 | |
| height) (in 4:4:4 chroma | | | | | | | | | | |
| format) | | | | | | | | | | |

The unified matrixId is derived as follows: matrixId=N*sizeId+matrixTypeId, where N is the number of possible type identifiers, e.g., N=6. This is based on:

a size identifier which relates to CU size listed by decreasing block size (i.e. CU enclosing square shape, because only square-size matrices are transmitted) rather than block size. Note here for either luma or chroma, the size identifier is controlled by the luma block size, e.g., max(luma block width, luma block height). When luma and chroma tree are separated, for chroma, “CU size” would refer to the size of the block projected on the luma plane. This identifier is illustrated in Table 5:

TABLE 5
Size identifier ordered by decreasing block size

| Luma | Chroma | sizeId |
|---|---|---|
| 64 × 64 | 32 × 32 | 0 |
| 32 × 32 | 16 × 16 | 1 |
| 16 × 16 | 8 × 8 | 2 |
| 8 × 8 | 4 × 4 | 3 |
| 4 × 4 | 2 × 2 | 4 |

a matrix type which first lists luma QMs, because they can be larger than chroma (e.g., in case of 4:2:0 chroma format), illustrated in Table 6:

TABLE 6
Matrix type identifier

| CuPredMode | cIdx (Colour component) | matrix TypeId |
|---|---|---|
| MODE_INTRA | 0 (Y) | 0 |
| MODE_INTER | 0 (Y) | 1 |
| MODE_INTRA | 1 (Cb) | 2 |
| MODE_INTER | 1 (Cb) | 3 |
| MODE_INTRA | 2 (Cr) | 4 |
| MODE_INTER | 2 (Cr) | 5 |

With such technique, instead of transmitting QM coefficients, it is possible to predict the QM either from default values, or from any previously transmitted one.
When the reference QM is the same size, is copied, otherwise it is decimated by the relevant ratio,
When the reference QM has a DC value
   If the current QM needs a DC value, it is copied as DC value
   Otherwise, it is copied to the top-left QM coefficient

This operation, named decimation, is described by the following equation:

ScalingMatrix[matrixId][x][y]=refScalingMatrix[i][j]
with matrixSize=(matrixId<20)? 8:(matrixId<26)? 4:2)
x=0 . . . matrixSize−1, y=0 matrixSize−1,
i=x«(log 2(refMatrixSize)−log 2(matrixSize)), and
j=y«(log 2(refMatrixSize)−log 2(matrixSize))

where refMatrixSize matches the size of refScalingMatrix (and thus the range of i and j variables).

This QM prediction process is part of the QM decoding process but could be deferred to the QM derivation process where the decimation for prediction purpose would be merged with the QM resize sub-process.

Back to table 4, one drawback is that when chroma format is 4:4:4 (chroma_format_idc==3 in SPS syntax), chroma QMs are not available in scaling list data syntax for size 32 or 64. In addition, when encoding in 4:4:4 chroma format, chroma QMs are signaled and used for every block size, but chroma QMs are intended for 4:2:0, thus are unduly subsampled for size 8 (4×4 chroma QMs) and 4 (2×2 chroma QMs), thus leading to lower quality of the resulting picture. Furthermore, chroma QMs are transmitted for size-2 although never used.

So far, scaling list data syntax is not depending on chroma format, to make it independently decodable: chroma_format_idc is signaled only in SPS, but scaling list data can be signaled in both SPS and PPS, and it is desired to keep PPS decoding independent of SPS. This means that scaling list data syntax can not make use of chroma_format_idc.

Embodiments described hereafter have been designed with the foregoing in mind. The encoder 100 of FIG. 1, decoder 200 of FIG. 2 and system 1000 of FIG. 3 are adapted to implement at least one of the embodiments described below and more particularly the quantization element 130 and inverse quantization elements 140 of the encoder 100 as well as the inverse quantization elements 240 of the encoder 200.

### First Embodiment: Chroma Format in QM Syntax

In at least one embodiment, the chroma_format_idc is signaled as part of the QM syntax, as highlighted in italic bold font on grey background in the syntax extract of Table 7.

TABLE 7
Chroma format in QM syntax

| scaling_list_data( ) { | Descriptor |
|---|---|
| scaling_list_chroma_format_idc | ue(v) |
| ... | |
| } | |

scaling list chroma_format_idc specifies the sampling resolution of chroma scaling matrices, in accordance with chroma format sampling structure. In at least one variant embodiment, the value of chroma_format_idc shall be in the range of 0 to 3, inclusive. It is a requirement of bitstream conformance that scaling_list_chroma_format_idc shall be equal to chroma_format_idc.

### Second Embodiment

In at least one embodiment, the chroma_format_idc is signaled directly at the PPS (picture parameter set) level, as highlighted in italic bold font on grey background in the syntax extract of Table 8. This can be particularly interesting if chroma format is needed for other syntax elements out of QMs (as an example, in HEVC 2018, a monochrome_palette_flag is introduced in the PPS). That way, specific chroma information is not repeated for each syntax element that needs it, thus reducing the overall size of the encoded video.

TABLE 8
Chroma format in PPS syntax

| Pic_parameter_set_rbsp( ) { | Descriptor |
|---|---|
| pps_pic_parameter_set_id | ue(v) |
| pps_seq_parameter_set_id | ue(v) |
| pps_chroma_format_idc | ue(v) |
| ... | |
| } | |

pps_chroma_format_idc specifies the chroma sampling relative to the luma sampling as specified in clause 6.2. In at least one variant embodiment, the value of chroma_format_idc shall be in the range of 0 to 3, inclusive. It is a requirement of bitstream conformance that pps_chroma_format_idc shall be equal to chroma_format_idc.

Since syntax structure name may change between different coding standard, it may be referenced in this document as xxx chroma_format_idc but with the same meaning, independently of the (level and) name of the syntax structure that contains the QM syntax.

Use of Chroma Format for QMs

Changes to QM syntax to use chroma format is dependent on the specific QM syntax. The general idea is that
chroma QMs should be consistent with luma QMs and chroma format:
   all block sizes shall have a specific QM, with optimal sampling. Rectangular chroma QMs might be signaled in 4:2:2 format, but in at least one embodiment it is proposed to keep subsampled square QMs in that case, increasing the number of coefficients for 4:4:4 only.
   no useless QMs shall be transmitted (such as unused sizeId like VVC draft 5)
chroma QMs should not be transmitted for monochrome encoding.
   that aspect is less important, since the overhead can be limited to 4 bits per sizeId (i.e. predicted chroma QMs). However it is the point of at least one embodiment to, when the chroma format is monochrome, transmit only a luma quantization matrix and no chroma quantization matrix, and otherwise (i.e. not monochrome) transmit amongst other information both a luma quantization matrix and a chroma quantization matrix.

Example changes to signaled QM size depending on chroma format and matrixId are illustrated in italic bold font on grey background in the syntax Table 9:

TABLE 9
Changes to signaled QM size

| | | | | | | | | | | | |
|---|---|---|---|---|---|---|---|---|---|---|---|
| Y | INTRA | 0 | | 6 | | 12 | | 18 | | 24 | |
| | INTER | 1 | | 7 | | 13 | | 19 | | 25 | |
| Cb | INTRA | | 2 | | 8 | | 14 | | 20 | | 26 |
| | INTER | | 3 | | 9 | | 15 | | 21 | | 27 |
| Cr | INTRA | | 4 | | 10 | | 16 | | 22 | | 28 |
| | INTER | | 5 | | 11 | | 17 | | 23 | | 29 |

| TU size | 64 | | 32 | | 16 | | 8 | | 4 | |
|---|---|---|---|---|---|---|---|---|---|---|
| Signaled QM size | 8 × 8 + DC | | | | | 8 × 8 | | 4 × 4 | | 2 × |
| (in 4:2:0 chroma format) | | | | | | | | | | 2 |
| Block size: max(width, height) | 64 | 32 | | 16 | | 8 | | 4 | | 2 |
| (in 4:2:0 chroma format) | | | | | | | | | | |
| [symbol] | [symbol] | | | | | | [symbol] | | [symbol] | |
| [symbol] | | | | | | | | | | |

| | | | | | |
|---|---|---|---|---|---|
| [symbol] | [symbol] | [symbol] | [symbol] | [symbol] | [symbol] |
| [symbol] | | | | | |

[symbol]

4:4:4 Chroma Format

Example changes to scaling list data syntax are are illustrated in italic bold font on grey background in the syntax Table 10:

TABLE 10
Changes to scaling list data syntax

| scaling_list_data( ) { | Descriptor |
|---|---|
| for( matrixId = 0; matrixId < 30; matrixId++ ) { | |
| scaling_list_pred_mode_flag[ matrixId ] | u(1) |
| if ( !scaling_list_pred_mode_flag[ matrixId ] ) | |
| scaling_list_pred_matrix_id_delta[ matrixId ] | ue(v) |
| else { | |
| nextCoef = 8 | |
| if (xxx_chroma_format_idc == 3) | |
| coefNum = (matrixId < 24) ? 64 : 16 | |
| else | |
| coefNum = (matrixId < 20) ? 64 : (matrixId < 26) ? 16 : 4 | |
| if ( (xxx_chroma_format_idc == 3 && matrixId < 18) \|\| | |
| (xxx_chroma_format_idc ~= 3 && matrixId < 14) ) { | |
| scaling_list_dc_coef_minus8[ matrixId ] | se(v) |
| nextCoef = scaling_list_dc_coef_minus8[ matrixId ] + 8 | |
| } | |
| for( i = 0; i < coefNum; i++ ) { | |
| scaling_list_delta_coef | se(v) |
| nextCoef = ( nextCoef + scaling_list_delta_coef + 256 ) % | |
| 256 | |
| ScalingList[ matrixId ][ i ] = nextCoef | |
| } | |
| } | |
| } | |
| } | |

Similar changes are required in semantics to derive the size of the reference matrix in case of prediction, and in QM derivation process to derive the correct QM size depending on matrixId, as shown below:

When chroma_format_idc equals 3, the variable log 2MatrixSize is derived as follows:

log 2MatrixSize=(matrixId<24)?3:2

otherwise, the variable log 2MatrixSize is derived as follows:

log 2MatrixSize=(matrixId<20)?3:(matrixId<26)?2:1

DC coefficient conditions also needs to be updated accordingly in the semantics and QM derivation process.

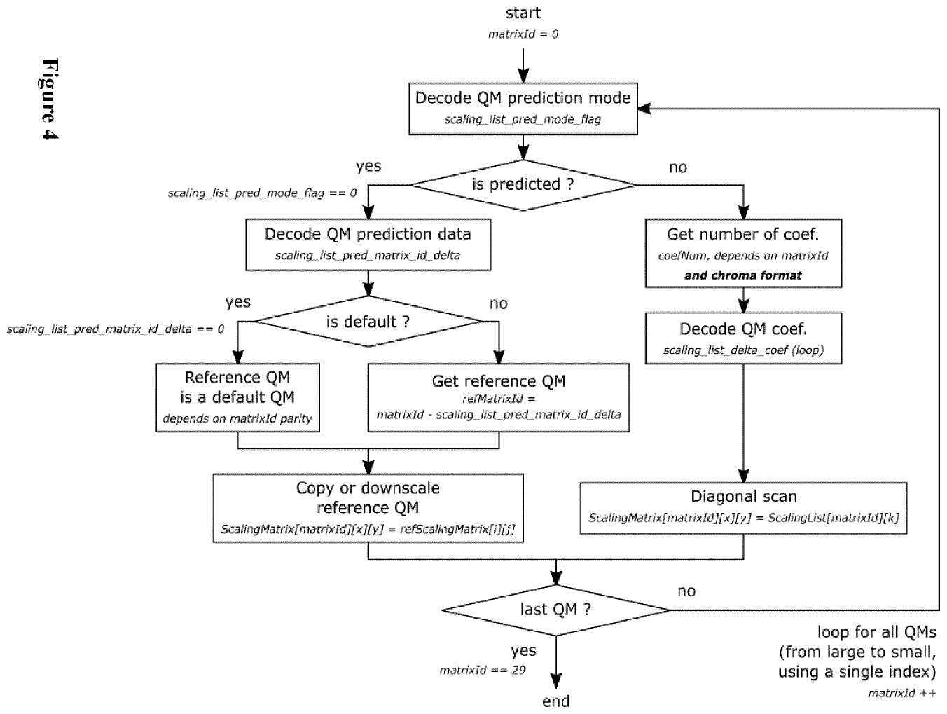

FIG. 4 illustrates an example flowchart of QM decoding according to at least one embodiment. The QM decoding flowchart now also depends on chroma format, as illustrated in the grey highlighted element of the figure. In this figure, Input is the coded bitstream and Output is an array of ScalingMatrix. The different steps are as follows:
“Decode QM prediction mode”: get a prediction flag from the bitstream.
“is predicted?”: determine if the QM is inferred (predicted) or signaled in the bitstream, depending on aforementioned flag.
“Decode QM prediction data”: get prediction data from the bitstream, needed to infer the QM when not signaled, e.g. a QM index difference scaling listpred matrix id delta
“is default”: determine if the QM is predicted from default values (e.g. if scaling listpred matrix id delta is zero), or from a previously decoded QM
“Reference QM is a default QM”: select a default QM as reference QM. There can be several default QMs to choose from, e.g. depending on the parity of matrixId.
“Get reference QM”: select a previously decoded QM as reference QM. The index of the reference QM is derived from matrixId and aforementioned index difference.
“Copy or downscale reference QM”: predict QM from reference QM. Prediction consists of a simple copy if reference QM is the correct size, or a decimation if it is larger than expected. Result is stored in ScalingMatrix[matrixId].
“Get number of coef”: determine the number of QM coefficients to be decoded from the bitstream, depending on matrixId and chroma format.
“Decode QM coef.”: decode the relevant number of QM coefficients from the bitstream
“Diagonal scan”: organize the decoded QM coefficients in a 2D matrix. Result is stored in ScalingMatrix[matrixId]
“last QM”: either loop or stop when all QMs are decoded from the bitstream. Details about the DC value are omitted for the sake of clarity.

### Monochrome Chroma Format

When in monochrome format (i.e. when xxx chroma_format_idc==0 or when a monochrome flag is set), signaling of chroma QMs can be skipped.

Different embodiments are proposed to cover the monochrome chroma format.
In at least one embodiment, it is proposed to:
reduce matrix count to 10 instead of 30
update matrixId mapping accordingly to select to correct QM depending on transform block parameters
update DC coefficient conditions

In this embodiment, the flowchart is the same as illustrated in FIG. 4 except that the “last QM?” condition is changed to “matrixId==9 ?” in monochrome format. Example changes to signaled QM size depending on chroma format and matrixId are illustrated in italic bold font on grey background in the syntax Table 11:

TABLE 11
QM index mapping for monochrome format in at least one embodiment

| | | | | | | | | | | | |
|---|---|---|---|---|---|---|---|---|---|---|---|
| Y | INTRA | 0 | | 2 | | 4 | | 6 | | 8 | |
| | INTER | 1 | | 3 | | 5 | | 7 | | 9 | |
| Cb | INTRA | | — | | — | | — | | — | | — |
| | INTER | | — | | — | | — | | — | | — |
| Cr | INTRA | | — | | — | | — | | — | | — |
| | INTER | | — | | — | | — | | — | | — |

| | | | | | |
|---|---|---|---|---|---|
| TU size | 64 | 32 | 16 | 8 | 4 |

| | | | |
|---|---|---|---|
| [symbol] | [symbol] | [symbol] | [symbol] |
| [symbol] | | | |

In at least one embodiment, it is proposed to:
Skip 2 QMs out of 3 in the for (matrixId . . . ) loop: matrixId+=3 instead of ++
Since skipping 2 QMs (the chroma ones) out of 3 may result in undefined chroma QMs, then either the chroma QMs shall be inferred to be predicted from known values, or scaling list_pred matrix id delta shall be restricted (reducing the set of QM to be predicted from) so that it is not possible to predict a luma QM from an undefined chroma QM, for example:
   Either force the delta value to be a multiple of 3 (i.e. point to a luma QM)
   Or multiply the delta value by 3 for the derivation of reference index:

refMatrixId=matrixId−scaling list_pred matrixid delta*3

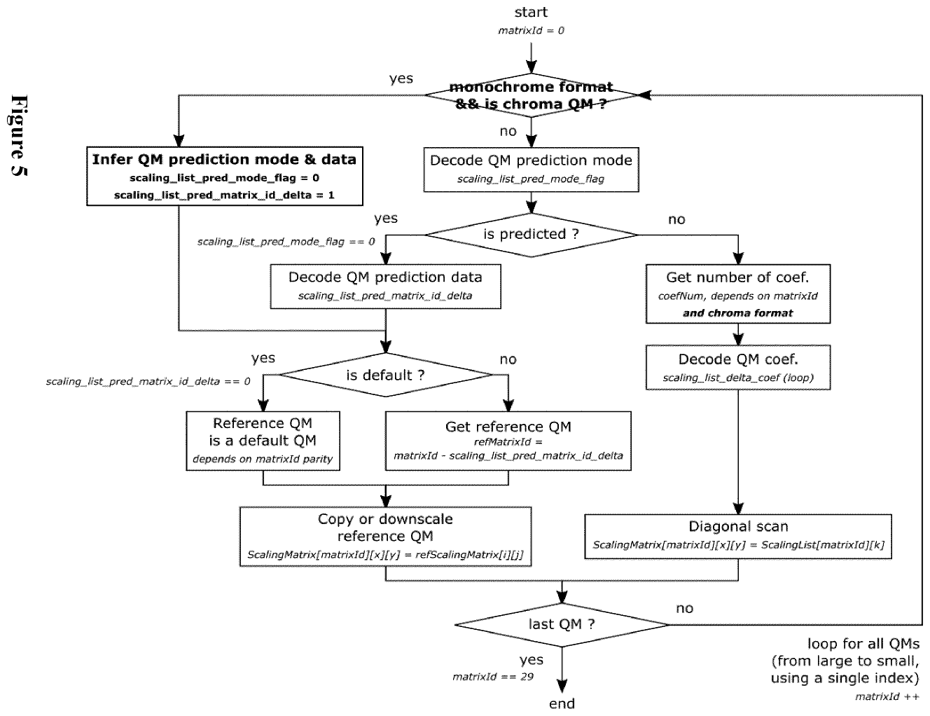

FIG. 5 illustrates an example flowchart of an embodiment where chroma QM are inferred. In at least such embodiment, independently from the syntax to be used, chroma QM syntax can be skipped by inferring them to be predicted from the preceding one: For chroma QMs (i.e. (matrixId % 3)>0 for HEVC/VVC draft 5 in scaling list data syntax),
infer scaling list_pred mode flag=0
infer scaling list_pred matrix id delta=1

When in monochrome format, the step “monochroma format && is chroma QM?” is added to determine if the current QM matrixId is a chroma QM (chroma_format_idc==0 && (matrixId % 6)>1 for JVET 00223). If that condition is true, the step “Infer QM prediction mode & data” is added to predict said chroma QM from the preceding QM in decoding order. “Get number of coef.” may or may not depend on chroma format, depending on whether this modification is combined with 4:4:4 adaptation in previous section. Modifications to the former QM decoding process of VVC draft 5 or HEVC are very similar.

For this embodiment, example changes to scaling list data syntax are are illustrated in italic bold font on grey background in the syntax Table 12:

TABLE 12
Changes to scaling list data syntax

| scaling_list_data( ) { | Descriptor |
|---|---|
| for( matrixId = 0; matrixId < 30; matrixId++ ) { | |
| if (xxx_chroma_format_idc == 0 & & (matrixId % 6) > 1) | |
| scaling_list_pred_mode_flag[ matrixId ] = 0 | |
| else | |
| scaling_list_pred_mode_flag[ matrixId ] | u(1) |
| if ( !scaling_list_pred_mode_flag[ matrixId ] ) { | |
| if (xxx_chroma_format_idc == 0 & & (matrixId % 6) > 1) | |
| scaling_list_pred_matrix_id_delta[ matrixId ] = 1 | |
| else | |
| scaling_list_pred_matrix_id_delta[ matrixId ] | ue(v) |
| } | |
| else { | |
| nextCoef = 8 | |
| coefNum = (matrixId < 20) ? 64 : (matrixId < 26) ? 16 : 4 | |
| if ( matrixId < 14 ) { | |
| scaling_list_dc_coef_minus8[ matrixId ] | se(v) |
| nextCoef = scaling_list_dc_coef_minus8[ matrixId ] + 8 | |
| } | |
| for( i = 0; i < coefNum; i++ ) { | |
| scaling_list_delta_coef | se(v) |
| nextCoef = ( nextCoef + scaling_list_delta_coef + 256 ) | |
| % 256 | |
| ScalingList[ matrixId ][ i ] = nextCoef | |
| } | |
| } | |
| } | |
| } | |

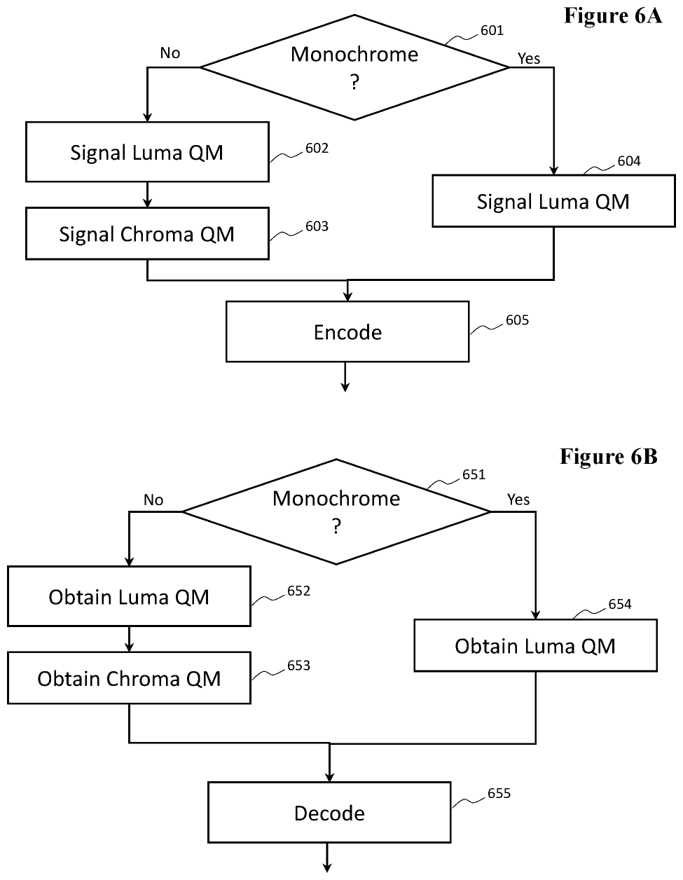

FIGS. 6A and 6B illustrate example flowcharts for encoding and decoding according to at least one embodiment. As introduced above, at least one embodiment proposes that, when the chroma format is monochrome (i.e. no colors are used), only a luma quantization matrix is transmitted and no chroma quantization matrix. Otherwise (i.e. not monochrome) at least both a luma quantization matrix and a chroma quantization matrix are transmitted. This allows to save some bits of data that would be otherwise wasted by transmitting an information that would never be used.

These principles are implemented both at the encoding device and at decoding device. Also, the bitstream generated to convey the video is also impacted since it may comprise information related to the chroma quantization matrix or not.

FIG. 6A describes an encoding method according to an embodiment. This method is for example performed by the encoder 1030 of device 1000. In step 601, the encoder determines if the chroma format is monochrome. As introduced above, the detection of monochrome format is for example done when the value of the chroma_format_idc flag is equal to zero, as shown in table 2. Another way to detect the use of monochrome format is by using a dedicated flag when available. When the chroma format is monochrome, in step 604, only the luma QM is signaled. When the chroma format is not monochrome, both the luma QM in step 602 and the chroma QM in step 603 are signaled. The order between the luma QM and chroma QM has no importance and the reverse order than the one presented here may be used. Then, in step 605, the video is encoded accordingly.

FIG. 6B describes a decoding method according to an embodiment. This method is for example performed by the decoder 1030 of device 1000. In step 651, the encoder determines if the chroma format is monochrome. This determination is done similarly to step 601. When the chroma format is monochrome, in step 654, only the luma QM is obtained. Indeed, in this case, no chroma QM is available. When the chroma format is not monochrome, both the luma QM in step 652 and the chroma QM in step 653 are obtained. Again, the order between the luma QM and chroma QM has no importance and the reverse order than the one presented here may be used. Then, in step 655, the video is encoded accordingly.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 1, 2 and 3 provide some embodiments, but other embodiments are contemplated and the discussion of these figures does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the motion compensation and motion estimation modules (170, 175, 275), of a video encoder 100 and decoder 200 as shown in FIG. 1 and FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, tablets, smartphones, cell phones, portable/personal digital assistants, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

In the present application, the terms “reconstructed” and “decoded” may be used interchangeably, the terms “pixel” and “sample” may be used interchangeably, the terms “image,” “picture”, “frame”, “slice” and “tiles” may be used interchangeably. Usually, but not necessarily, the term “reconstructed” is used at the encoder side while “decoded” is used at the decoder side.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of an illumination compensation parameter. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1-11. (canceled)

12. A method comprising:
obtaining, from video data, encoded data representative of a picture, wherein the picture is monochrome;
obtaining, from the encoded data, information representative of a prediction of chroma quantization matrices;
inferring chroma quantization matrices from an obtained luma quantization matrix; and
decoding the encoded data using the obtained luma quantization matrix and the inferred chroma quantization matrices.

13. The method of claim 12, wherein the chroma quantization matrices are not present in the video data.

14. The method of claim 12, wherein the information representative of a prediction of chroma quantization matrices is a flag defined by the versatile video coding specification as scaling_listpred_mode_flag, wherein the flag has a value of zero.

15. A method comprising:
obtaining from video data, picture data representative of a picture, wherein the picture is monochrome;
matrix;
obtaining, from the picture data, chroma quantization matrices and a luma quantization encoding information representative of a prediction of chroma quantization matrices;
encoding information representative of the luma quantization matrix, while skipping the chroma quantization matrices; and
encoding the picture data using the obtained chroma quantization matrices and the luma quantization matrix.

16. The method of claim 15, wherein the information representative of a prediction of chroma quantization matrices is a flag defined by the versatile video coding specification as scaling_listpred_mode_flag, wherein the flag has a value of zero.

17. A device comprising a processor configured to:
obtain, from video data, encoded data representative of a picture, wherein the picture is monochrome;
obtain, from the encoded data, information representative of a prediction of chroma quantization matrices;
infer chroma quantization matrices from an obtained luma quantization matrix; and
decode the encoded data using the obtained luma quantization matrix and the inferred chroma quantization matrices.

18. The device of claim 17, wherein the chroma quantization matrices are not present in the video data.

19. The device of claim 17, wherein the information representative of a prediction of chroma quantization matrices is a flag defined by the versatile video coding specification as scaling_listpred_mode_flag, wherein the flag has a value of zero.

20. A device comprising a processor configured to:
obtain from video data, picture data representative of a picture, wherein the picture is monochrome;
obtain, from the picture data, chroma quantization matrices and a luma quantization matrix;
encode information representative of a prediction of chroma quantization matrices;
encode information representative of the luma quantization matrix while skipping the chroma quantization matrices; and
encode the picture data using the obtained chroma quantization matrices and the luma quantization matrix.

21. The device of claim 20, wherein the information representative of a prediction of chroma quantization matrices is a flag defined by the versatile video coding specification as scaling_listpred_mode_flag, wherein the flag has a value of zero.

22. Non-transitory computer readable medium comprising program code instructions for implementing the steps of a method according to claim 12 when executed by a processor.
